(19) United States
(12) Patent Application Publication
(10) Pub. No.: US 2025/0252445 A1
(43) Pub. Date: Aug. 7, 2025

(54) FRAUD ASSISTANT LARGE LANGUAGE MODEL

(71) Applicant: Wells Fargo Bank, N.A., San Francisco, CA (US)

(72) Inventor: Ajit Gaddam, Danville, CA (US)

(21) Appl. No.: 19/046,092

(22) Filed: Feb. 5, 2025

Related U.S. Application Data
(60) Provisional application No. 63/551,028, filed on Feb. 7, 2024.

(51) Int. Cl. G06Q 20/40; G06F 16/3329; H04L 51/02

(52) U.S. Cl. CPC G06Q 20/4016; G06F 16/33295; H04L 51/02

(57) ABSTRACT

Systems and techniques may generally be used for chatbot-based fraud assistance. An example method may include initiating a chatbot session with a user and receiving a prompt from the user related to suspected suspicious activity in an account. The method may include retrieving, using a Retrieval-Augmented Generation (RAG) component, contextual information from at least one of transaction data and a knowledge base. The method may include evaluating the prompt using a large language fraud model and the retrieved contextual information to determine a response.

### CLAIM OF PRIORITY

This application claims the benefit of priority to U.S. Provisional Application No. 63/551,028 filed Feb. 7, 2024, titled “FRAUD ASSISTANT LARGE LANGUAGE MODEL,” which is hereby incorporated herein by reference in its entirety.

### BACKGROUND

Traditional fraud detection systems face difficulty in effectively addressing the growing volume and complexity of customer interactions related to fraud. Current methods often depend on manual processes and fragmented technologies, which can result in slow response times and an increased workload for fraud specialists. These limitations hinder the ability to quickly identify suspicious activities and provide timely assistance to customers.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram for chatbot-based fraud assistance in accordance with some examples.

FIG. 2 illustrates a data flow diagram for chatbot-based fraud assistance in accordance with some examples.

FIG. 3 illustrates a machine learning engine for training and execution related to a large language model (LLM) for a fraud chatbot in accordance with some examples.

FIGS. 4A-4E illustrate examples of fraud chatbot interactions for a fraud chatbot system in accordance with some examples.

FIG. 5 illustrates a flowchart showing a technique for chatbot-based fraud assistance in accordance with some examples.

FIG. 6 illustrates generally an example of a block diagram of a machine upon which any one or more of the techniques discussed herein may perform in accordance with some examples.

### DETAILED DESCRIPTION

The systems and techniques described herein may be used to initiate a chatbot session with a user, receive a prompt from the user related to suspected suspicious activity in an account, and evaluate the prompt to determine a response. The chatbot may use a large language fraud model (e.g., a large language model (LLM) trained to detect fraud) with retrieval-augmented generation (RAG) to process a user input and provide a contextually relevant response, for example constrained to a particular context via the RAG. When a user initiates a chatbot session, the user may input text, audio, or video, which may be processed to identify details, such as transaction amounts, dates, descriptions of suspicious activities, etc.

To ensure accurate and contextually aware engagement, RAG may be used to provide context, such as via structured or unstructured data sources, transaction histories, fraud prevention guidelines, customer profiles, or the like. The retrieved context may be provided to the large language fraud model to refine response generation, which may be provided to the chatbot. The chatbot may use a response generated by the large language fraud model to provide relevant advice, actions, or next steps tailored to a specific situation of a user. For example, the chatbot may recommend freezing an account, contacting a fraud specialist such as when additional verification is required, offer educational tips on avoiding fraud, etc.

RAG may be performed using data components such as transaction data or a knowledge base of documents pulled from public or private sites. Data may be stored in and retrieved from a vector database or stored in a relational database (e.g., SQL, SQLite, etc.), in some examples. The vector database may store document content as numerical vector representations that capture semantic meaning, enabling similarity-based retrieval of contextually relevant information. When generating context via RAG, a vector input (e.g., generated from a user prompt or a query generated from the user prompt) may be compared to a corpus of documents using one or more similarity metrics to identify and retrieve the context. In some examples, the a similarity metric may include a cosine similarity between a query vector and document vectors.

An example technique may include initiating a chatbot session with a user, receiving a prompt related to suspected suspicious activity in an account, and evaluating the prompt to determine an appropriate response. The chatbot system may use a large language fraud model in combination with RAG to evaluate a natural language input, retrieve relevant information from transaction data or a knowledge base, and provide a context-aware response without requiring direct interaction with a human agent.

In some examples, RAG may be used to anchor an output of a LLM by referring to authoritative, optionally proprietary, relational data or a knowledge base, such as one from external sources. For example, RAG may be used to retrieve supplemental information from multiple data sources, such as structured data sources including transaction histories stored in a SQLite relational database management system, or unstructured data sources containing fraud prevention guidelines, or cybersecurity protection information stored in a vector database.

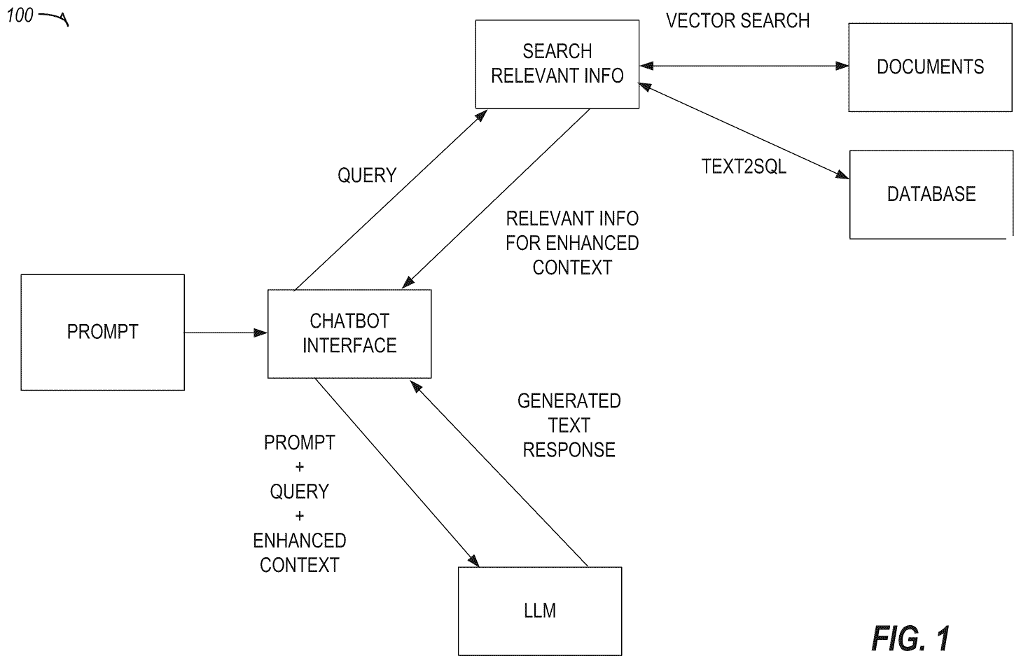

FIG. 1 illustrates a block diagram 100 for chatbot-based fraud assistance in accordance with some examples. The block diagram 100 includes a chatbot block, an LLM block, and a RAG block. The RAG block may be used to search relevant information, such as documents (e.g., in a curated corpus), a database (e.g., of account or customer data), or the like. A user may generate a prompt, which is input to a chatbot. The chatbot may generate a query (e.g., using the LLM), which may be checked using RAG on a set of documents or a database. The RAG may return context to the chatbot. The chatbot may send the prompt, query, and context to the LLM. The LLM may generate a text response for the chatbot to respond to the prompt. In some examples, the LLM generates a response to the prompt, the query, or the prompt and query. This response may be sent to the RAG block by the chatbot to check for context on the response. The context may be sent by the chatbot to the LLM, such as iteratively. For example, the LLM generates a response based on the context, which may then be checked using RAG. In some examples, the LLM may generate a new query based on the context for consideration at the RAG block.

In some examples, the documents or the database may be populated by customer call transcripts generated via voice-to-text data analysis. Automated data compilation may be used to label data from the transcripts (e.g., helpful solutions, situations calling for education or enhanced security, etc.).

The block diagram 100 may incorporate data compilation features that may gather and organize account information, transaction histories, and customer interaction data. In some examples, the system may autonomously retrieve pertinent account details and combine multiple data sources to create comprehensive case profiles. In another example, the system may synthesize information to provide detailed background information for each investigation.

The chatbot may present organized data through an interface that may highlight patterns indicating potential fraudulent activity. In some examples, the block diagram 100 may reduce manual data retrieval time by automating the collection and organization of relevant case information. In another example, the block diagram 100 may enable fraud specialists to focus on fraud analysis by managing routine data gathering tasks. In an example, the chatbot may display information patterns that may help identify suspicious transaction activities. The block diagram 100 may integrate with existing fraud detection infrastructure. In some examples, the system may connect with established AI platforms to enhance fraud prevention capabilities.

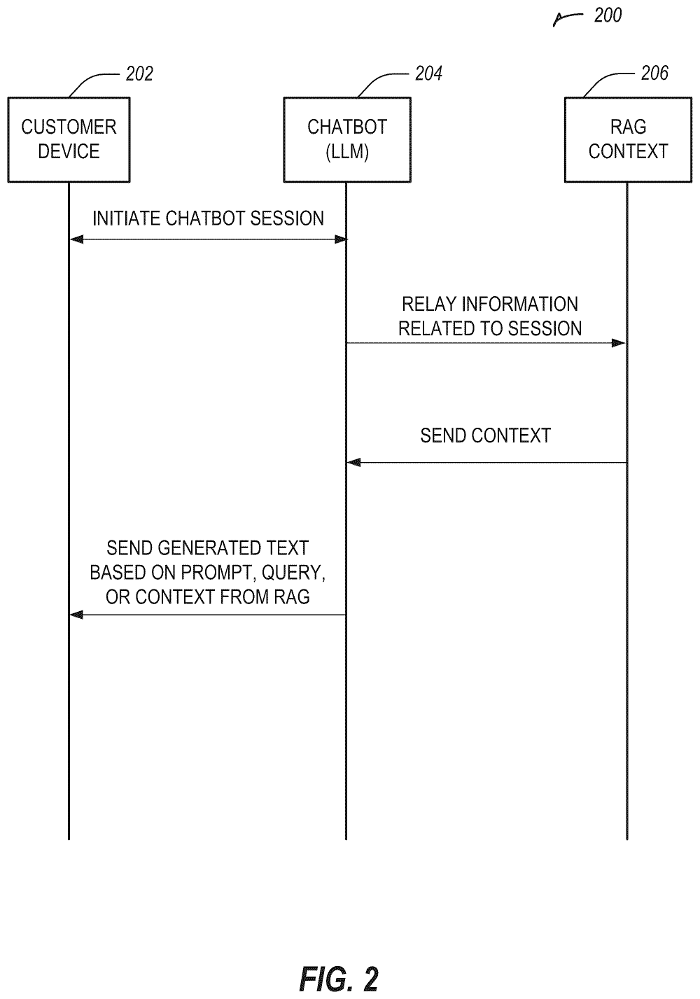

FIG. 2 illustrates a data flow diagram 200 for chatbot-based fraud assistance in accordance with some examples. The data flow diagram 200 includes a customer device 202, a chatbot 204 (e.g., including or accessing an LLM), and a RAG context 206.

The customer device 202 or the chatbot 204 may initiate a chatbot session, for example related to a potential fraudulent transfer or transaction. The customer device 202 may send text, such as a prompt or query. The chatbot 204 may generate a query from a prompt (e.g., using an LLM). The chatbot 204 may relay information related to the session, such as the prompt or query to the RAG context 206. In some examples, this relaying may be done automatically, such as by having the RAG context 206 receive the information from the customer device 202. The RAG context 206 may send context to be used by the chatbot 204 in responding to the customer device 202. The chatbot may send generated text (e.g., from the LLM using the context) based on the prompt, the query, or the context from the RAG context 206.

The customer device 202 may serve as the user interface through which customers may interact with the chatbot 204. In some examples, the customer device 202 may initiate a chatbot session when suspicious account activity is detected. In another example, the chatbot 204 may initiate the session in response to potential fraudulent transfers or transactions. The chatbot 204 may incorporate LLM technology to process and respond to customer interactions. In some examples, the chatbot 204 may analyze natural language inputs to identify details about suspicious activities. In another example, the chatbot 204 may interpret transaction amounts, dates, or descriptions provided by customers.

The RAG context 206 may enhance the chatbot 204's response capabilities by providing relevant contextual information. In some examples, the RAG context 206 may retrieve supplemental information from structured or unstructured data sources, including transaction histories or fraud prevention guidelines. The chatbot 204 may access customer profiles to provide context-aware engagement. In some examples, the chatbot 204 may automatically relay a prompt or query to the RAG context 206. In another example, the RAG context 206 may receive information directly from the customer device 202.

The RAG context 206 may process the received information and send relevant context back to the chatbot 204. In another example, the context may include fraud prevention guidelines from a knowledge base.

The chatbot 204 may generate a response using the customer input and the context provided by the RAG context 206 as inputs to an LLM. In some examples, the chatbot 204 may recommend freezing an account based on a detected anomaly or in response to a high-risk activity. A high-risk activity may include multiple transactions occurring on the same date, transactions with unusual amounts, transactions outside normal patterns, suspicious login attempts, or the like. In an example, the chatbot 204 may suggest contacting a fraud specialist when additional verification is required. In some examples, high-risk activities may trigger step-up authentication requirements or temporary account holds based on the system's analysis of transaction patterns and account access behaviors.

A response to a prompt may include a security measure, which may include a duration specification based on a risk level. For example, a temporary account hold may remain active until a fraud specialist completes an investigation of the suspicious activity. In an example, progressive security measures may be recommended, such as starting with a transaction restriction before escalating to an account freeze based on a further detected suspicious pattern.

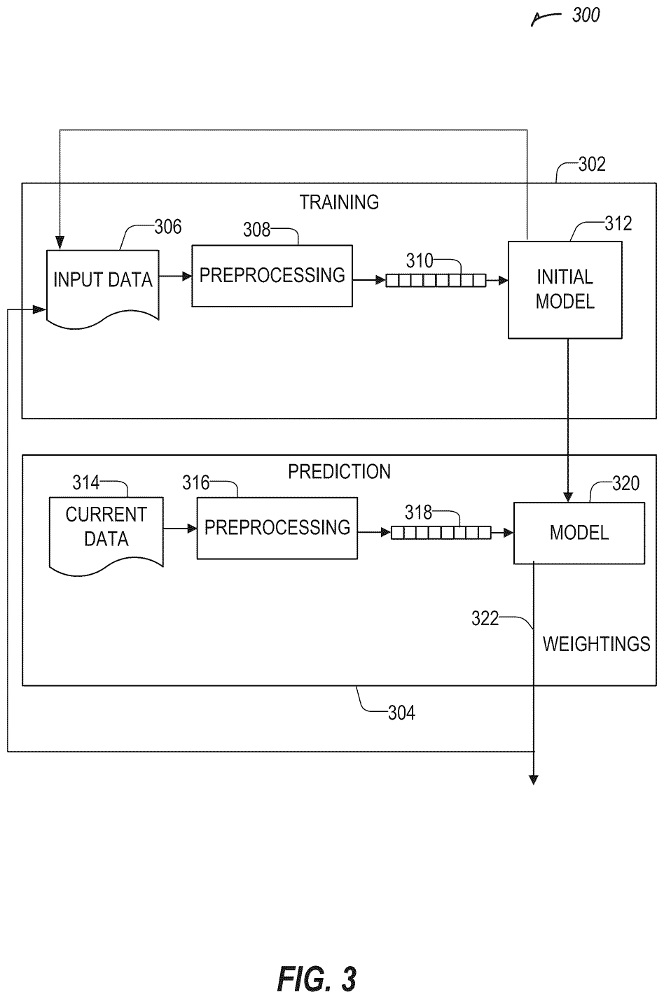

FIG. 3 illustrates a machine learning engine for training and execution related to an LLM for a fraud chatbot accordance with some examples. The machine learning engine may be deployed to execute at a mobile device (e.g., a cell phone) or a computer (e.g., an orchestrator server). A system may calculate one or more weightings for criteria based upon one or more machine learning algorithms. FIG. 3 shows an example machine learning engine 300 according to some examples of the present disclosure.

Machine learning engine 300 uses a training engine 302 and a prediction engine 304. Training engine 302 uses input data 306, for example after undergoing preprocessing component 308, to determine one or more features 310. The one or more features 310 may be used to generate an initial model 312, which may be updated iteratively or with future labeled or unlabeled data (e.g., during reinforcement learning), for example to improve the performance of the prediction engine 304 or the initial model 312. An improved model may be redeployed for use.

The input data 306 may include a large set of natural language (e.g., sufficient for training an LLM). In some examples, the input data 306 may include document data, such as for tuning or further training an LLM based on RAG data (e.g., a document corpus). In the prediction engine 304, current data 314 (e.g., a chatbot session) may be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction engine 304 may be designed to operate in an online manner (e.g., in real-time, at a mobile device, on a wearable device, etc.). In some examples, the model 320 may be periodically updated via additional training (e.g., via updated input data 306 or based on labeled or unlabeled data output in the weightings 322) or based on identified future data, such as by using reinforcement learning to personalize a general model (e.g., the initial model 312) to a particular user or purpose.

Labels for the input data 306 may include a weighting or rating of confidence in the truthfulness of the data. For example, a set of documents may be labeled as trustworthy for purposes of using a RAG component as context for an LLM. In some examples, no labeled data may be used (e.g., unsupervised learning). In other examples, some limited supervision may be used (e.g., to exclude particular words, phrases, concepts, etc., such as those that may be illegal or offensive).

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 320 may output a generated text, such as a response to a query or prompt from a user. The prediction may include using context from a RAG component in determining an output. The model 320 may be retrained over time, in some examples.

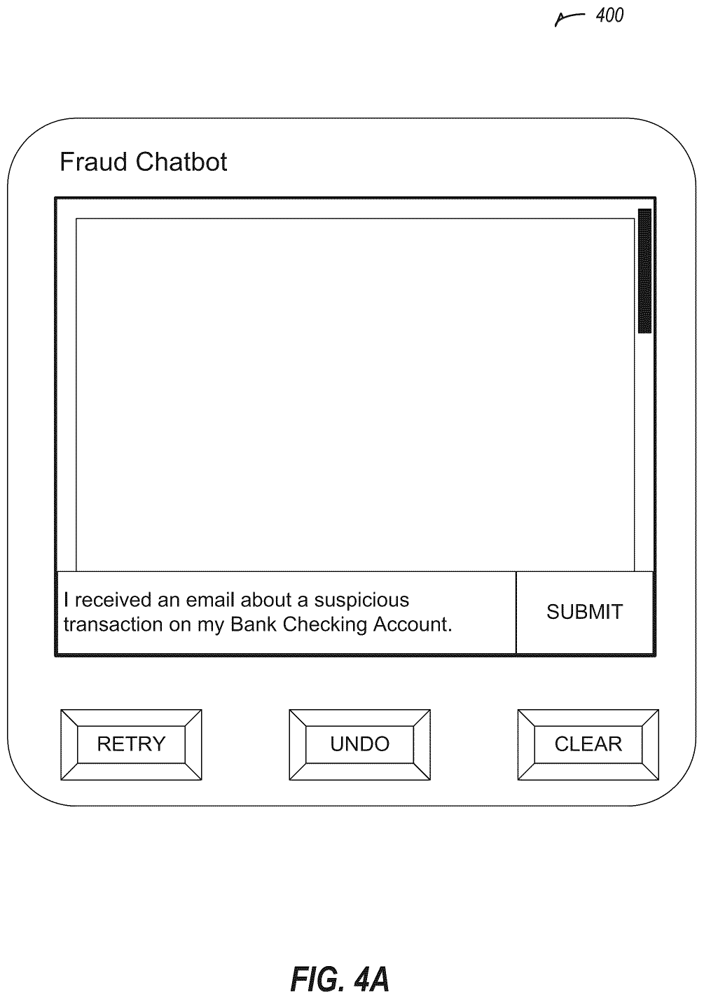

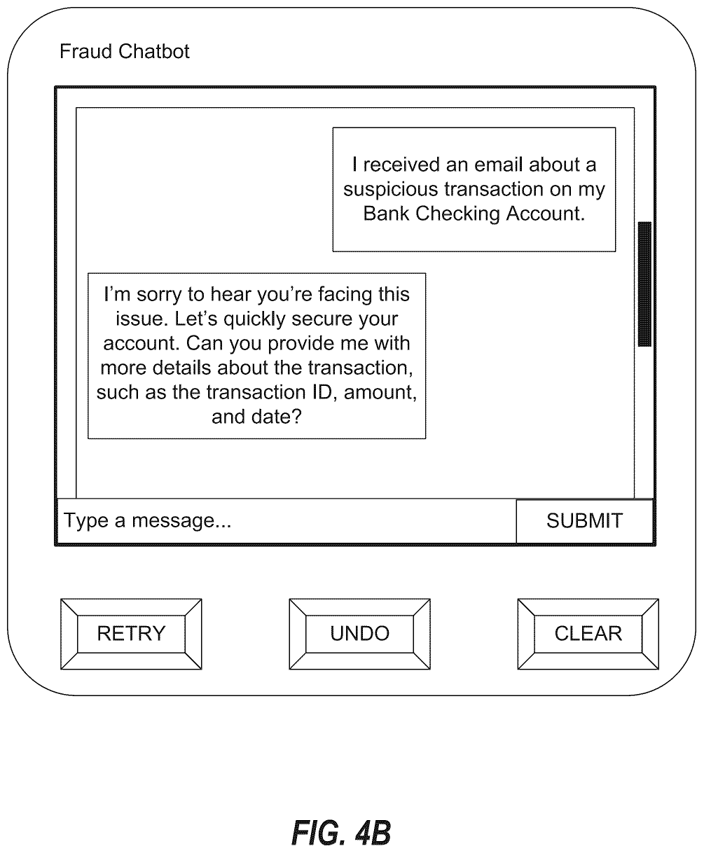

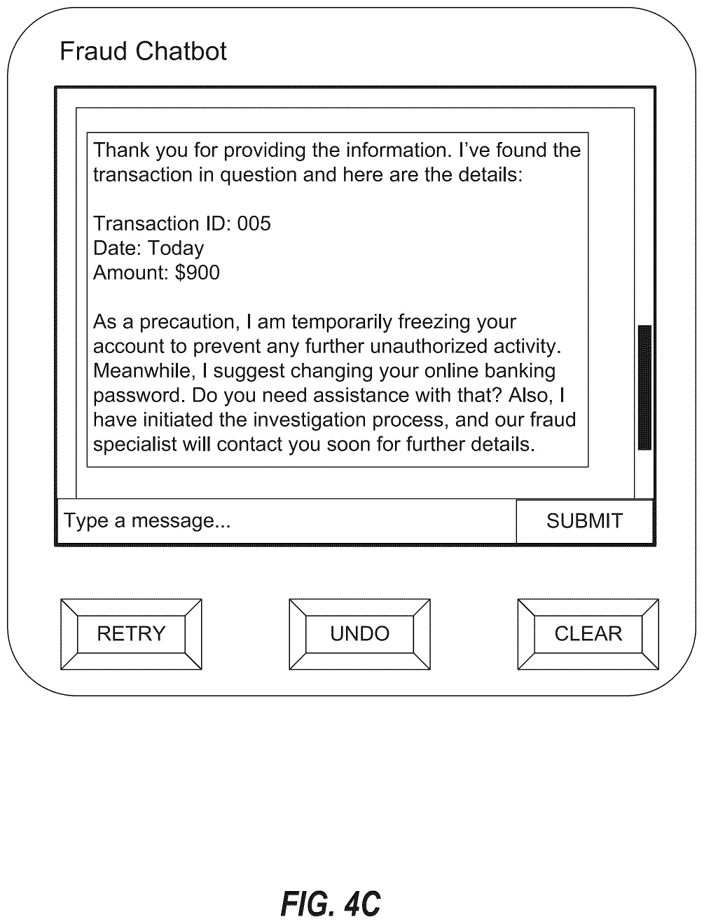

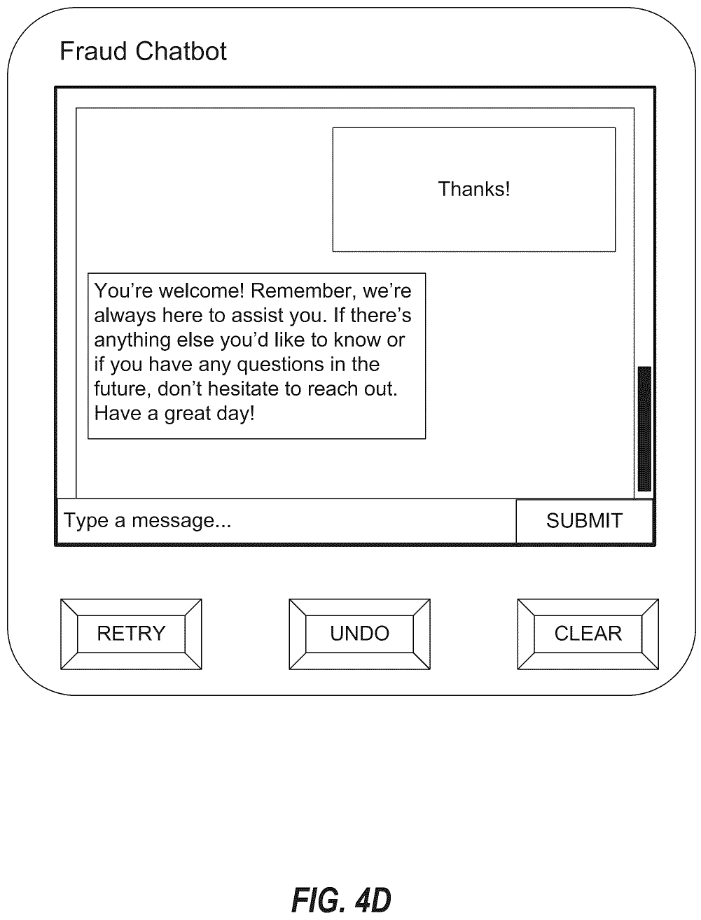

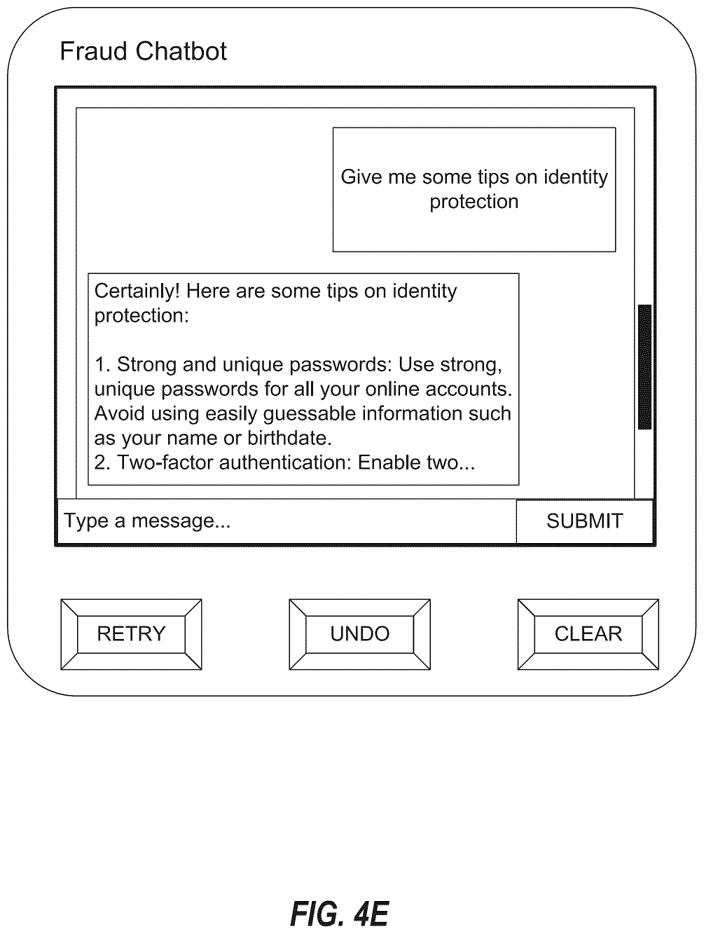

FIGS. 4A-4E illustrate example fraud chatbot interactions in accordance with some examples.

Table 1 illustrates an example list of recent transactions for a particular customer.

TABLE 1
List of Recent Transactions for Customer A

| ID | Date | Amount |
|---|---|---|
| 001 | 2024 Jan. 29 | $123.45 |
| 002 | 2024 Feb. 2 | $1000.00 |
| 003 | 2024 Feb. 2 | $99.99 |
| 004 | 2024 Feb. 4 | $900.09 |
| 005 | 2024 Feb. 5 | $900.00 |

FIG. 4A illustrates a first instance 400 of a user interface including a fraud chatbot. The first instance 400 includes a text input field where a customer may enter an initial prompt describing a potential fraudulent transaction. A customer may report a suspicious email related to an account, an unfamiliar charge or transaction, a suspicious call, a suspicious text message, etc. For example, the first instance 400 includes “I received an email about a suspicious transaction on my Bank Checking Account” as an entered prompt. The first instance 400 may include interface elements such as “SUBMIT,” “RETRY,” “UNDO,” and “CLEAR” buttons to enable a customer to manage an interaction with the chatbot.

FIG. 4B illustrates a second instance 402 of the user interface after the chatbot responds to the prompt from the customer. The chatbot responds by requesting further information, stating, “I′m sorry to hear you're facing this issue. Let's quickly secure your account. Can you provide me with more details about the transaction, such as the transaction ID, amount, and date?” The chatbot's response in the second instance 402 demonstrates an understanding of the prompt, and a request for further information. In some examples, the chatbot may request specific transaction details such as transaction ID, amount, and date to match against recent account activity. The second instance 402 displays the conversation in a structured format with the customer's message right justified and the chatbot's response left justified. The chatbot may process the prompt about the suspicious email and use the prompt to generate a query for input to an LLM or for RAG.

FIG. 4C illustrates a third instance 404 of the user interface after the customer has provided a response to the question in the second instance 402, and after the chatbot has responded by summarizing the customer's input. The third instance 404 states, “Thank you for providing the information. I've found the transaction in question and here are the details:
Transaction ID: 005
Date: Today
Amount: $900

As a precaution, I am temporarily freezing your account to prevent any further unauthorized activity. Meanwhile, I suggest changing your online banking password. Do you need assistance with that? Also, I have initiated the investigation process, and our fraud specialist will contact you soon for further details.” Here the chatbot has summarized the transaction identifier, date, and amount of a transaction that may be suspicious. The chatbot indicates a temporary freeze to the account as well and recommends changing a password. The text in the third instance 404 may be generated by an LLM based on the customer's previous input, along with RAG context corresponding to the customer's previous input (and optionally the original prompt). For example, the prompt with detailed information may be used to generate a query, and RAG is used to generate context that the information in the query indicates fraud (e.g., based on the amount, the account, etc.). From the prompt or query, the LLM may generate the summary of the transaction, and from the context, generate the indication of freezing the account. FIG. 4D illustrates a fourth instance 406 of the user interface including further chats between the customer and the chatbot.

FIG. 4E a fifth instance 408 of the user interface (or a new user interface, such as a different chatbot interaction session) including a prompt for tips on identity protection. Based on this prompt, a query may be generated and context may be obtained via RAG. The RAG context may indicate that the customer would benefit from or appreciate further education, and the LLM may generate a list of tips on identity protection. For example, the chatbot states, “Certainly! Here are some tips on identity protection:
1. Strong and unique passwords: Use strong, unique passwords for all your online accounts. Avoid using easily guessable information such as your name or birthdate.
2. Two-factor authentication: Enable two . . . ”

The LLM may generate the list based on information in a corpus of documents output as RAG context from a knowledge base. The corpus of documents may include fraud protection tips, past fraud, solutions to past fraud, etc. The LLM may generate a response that is contextualized to the information in the corpus of documents so that the LLM does not hallucinate or provide misinformation.

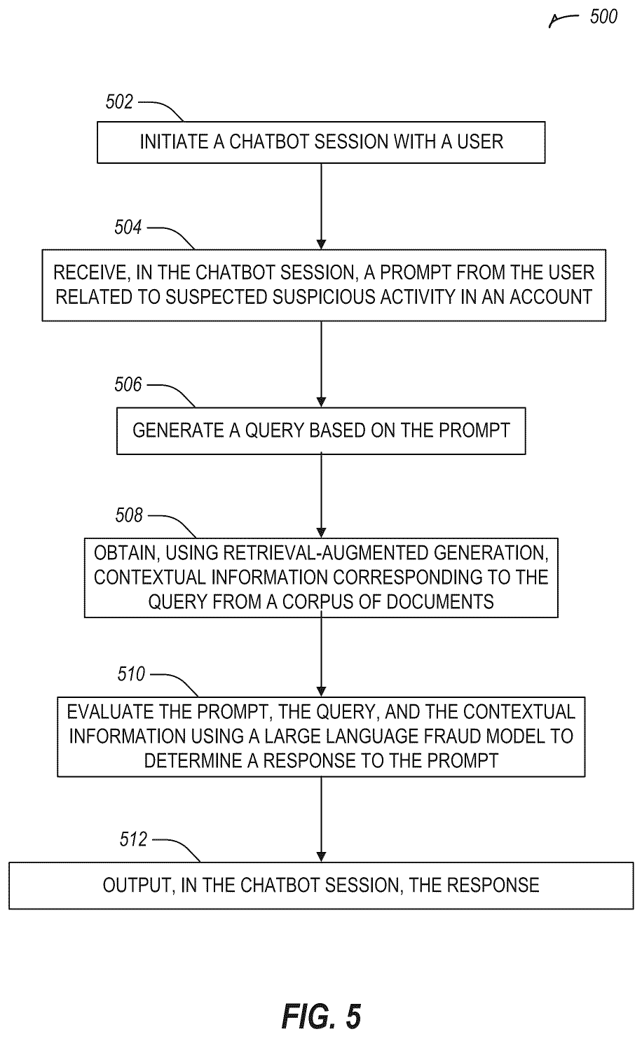

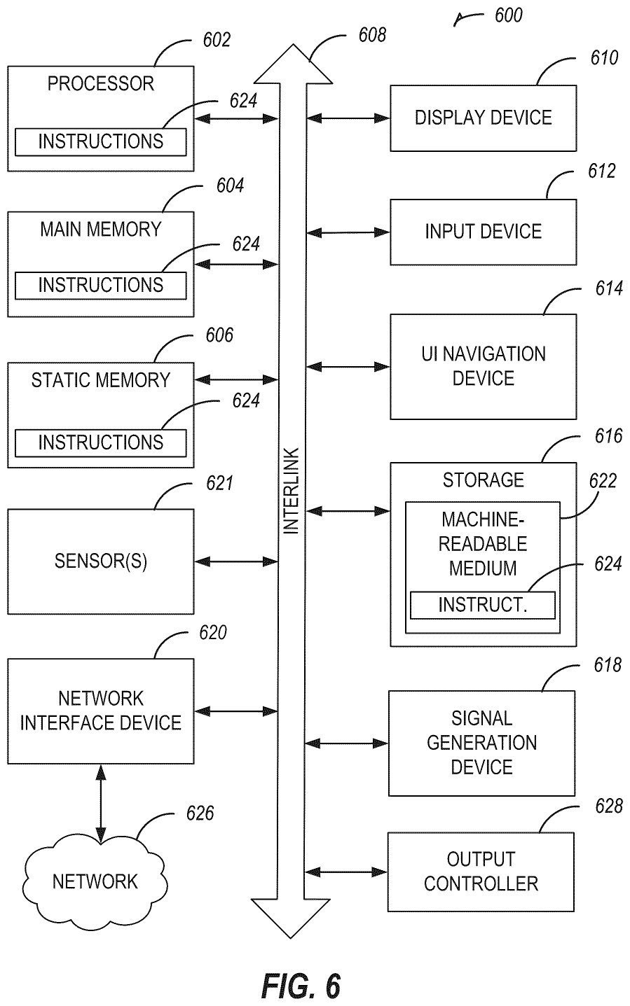

FIG. 5 illustrates a flowchart showing a technique 500 for chatbot-based fraud assistance in accordance with some examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to initiate a chatbot session with a user. Operation 502 may include initiating the chatbot session in response a step-up authentication requirement (e.g., based on a potentially suspicious transaction or interaction with the user, identifying an unusual account access pattern, requiring identity verification, or responding to a high-risk account activity). In some examples, the chatbot session may be initiated when detecting potentially suspicious transactions. In an example, the chatbot session may be initiated in response to step-up authentication requirements based on user interactions. The chatbot session may verify a user identity through a knowledge-based authentication question. In some examples, the chatbot session may be initiated may generate security questions based on account history. In an example, the chatbot session may be initiated may analyze user responses for future authentication purposes.

In an example, the chatbot session is initiated to verify the user through a knowledge-based question. In this example, the technique 500 may include sending, in the chatbot session, the knowledge-based question to the user, receiving an answer to the knowledge-based question from the user in the chatbot session, and using the answer as part of a behavior biometric sample of the user for authentication. In some versions of this example, the technique 500 includes initiating a second chatbot session with a user, receiving, in the chatbot session, at least one message from the user, and authenticating the user based on at least a threshold match between a biometric sample corresponding to the at least one message and the behavior biometric sample.

The technique 500 includes an operation 504 to receive, in the chatbot session, a prompt from the user related to suspected suspicious activity in an account. The prompt may relate to a suspicious email received, an account transaction, a fraud alert, an unfamiliar charge, or the like. The chatbot session may use an LLM to interpret a natural language prompt received. The LLM may output (e.g., for use in the chatbot session) details about suspicious activities, such as transaction amounts, dates, or merchant descriptions.

The technique 500 includes an operation 506 to generate a query based on the prompt. The query may be used for RAG searching of a corpus of documents. The technique 500 includes an operation 508 to obtain, using retrieval-augmented generation, contextual information corresponding to the query from a corpus of documents. The contextual information may include educational information for the user, information corresponding to whether a transaction or pattern of transactions represents fraud, etc. In some examples, operation 508 may include conducting a vector search across a document repository including fraud prevention guidelines and cybersecurity protection information. A vector search may involve converting document content and queries into numerical representations (vectors) that capture semantic meaning.

The technique 500 includes an operation 510 to evaluate the prompt, the query, and the contextual information using a large language fraud model to determine a response to the prompt. Operation 510 may result in a response including educational materials provided through the chatbot session. For example, protection tips may be shared drawn from the knowledge base (e.g., the RAG contextual information).

The system may utilize a large language fraud model to process prompts and generate responses, where the large language fraud model may be specifically trained and tuned for fraud detection scenarios using chatbot session data or verified fraud investigation outcomes. The model may incorporate specialized capabilities for processing transaction data, analyzing behavioral patterns, or identifying potential fraud indicators through natural language understanding. The model's outputs may be verified by comparing them against retrieval-augmented generation results from verified document sources, ensuring accuracy through multiple validation steps.

The large language fraud model may be iteratively improved through expert labeling and feedback loops, where fraud specialists' input may be used to refine the model's fraud detection capabilities. In some examples, the model may process voice-to-text data in real-time while simultaneously analyzing content for fraud indicators and suspicious patterns. In an example, the model may adapt its analysis approach based on verified suspicious activity reports and successful fraud investigation outcomes. The model may demonstrate measurable improvements in fraud detection precision through this iterative learning process, incorporating new fraud patterns and techniques as they emerge.

The model may interface with multiple data sources through defined workflows, accessing transaction records, customer profiles, and fraud prevention guidelines to inform its response generation. In some examples, the model may analyze transaction patterns between specific amounts and date ranges to identify potential fraud indicators. In another example, the model may evaluate behavioral biometric data during authentication processes to enhance security measures. The model may integrate with existing fraud detection infrastructure to provide comprehensive fraud prevention capabilities while maintaining customer service quality through natural language interaction.

The large language fraud model may access customer account data during the evaluation process. In some examples, the model may retrieve transaction histories. The model may analyze patterns of account activity to identify potential fraud indicators. In some examples, the model may use chatbot session data to refine its response generation. The model may adapt its fraud detection patterns based on verified suspicious activity reports. In some examples, the model may enhance the response determination through analysis of successful fraud investigation outcomes.

The technique 500 includes an operation 512 to output, in the chatbot session, the response. The response may indicate that the suspected suspicious activity corresponded to fraud in the account, and further comprising placing a hold on the account. The response may include indicating that the suspected suspicious activity does not correspond to fraud in the account, for example based on information identified in the corpus of documents during the RAG. The response may include indicating that a security measure has been taken, such as temporary account freezing, based on the evaluation results.

FIG. 6 illustrates generally an example of a block diagram of a machine 600 upon which any one or more of the techniques (e.g., methodologies) discussed herein may perform in accordance with some examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: initiating a chatbot session with a user; receiving, in the chatbot session, a prompt from the user related to suspected suspicious activity in an account of the user; generating a query based on the prompt; obtaining, using retrieval-augmented generation (RAG), contextual information corresponding to the query from corpus of documents; evaluating the prompt, the query, and the contextual information using a large language fraud model to determine a response to the prompt; and outputting, in the chatbot session, the response.

In Example 2, the subject matter of Example 1 includes, wherein the contextual information is obtained via a vector search of a corpus of documents.

In Example 3, the subject matter of Examples 1-2 includes, wherein the large language fraud model is configured to retrieve customer data corresponding to the account.

In Example 4, the subject matter of Examples 1-3 includes, wherein the large language fraud model is retrained using chatbot session data.

In Example 5, the subject matter of Examples 1-4 includes, wherein the response indicates that the suspected suspicious activity corresponded to fraud in the account, and further comprising placing a hold on the account.

In Example 6, the subject matter of Examples 1-5 includes, wherein the response to the prompt includes implementing at an account security measure including at least one of temporarily suspending account access, placing a hold on new transactions using the account, restricting electronic fund transfers using the account, disabling online banking capabilities of the account, or preventing charges to the account.

In Example 7, the subject matter of Examples 1-6 includes, wherein the response to the prompt includes providing educational materials to the user in the chatbot session.

In Example 8, the subject matter of Examples 1-7 includes, wherein the chatbot session is initiated in response to a step-up authentication requirement including at least one of detecting a potentially suspicious transaction pattern, identifying an unusual account access pattern, or requiring identity verification.

In Example 9, the subject matter of Examples 1-8 includes, wherein the chatbot session is initiated to verify the user through a knowledge-based question.

In Example 10, the subject matter of Example 9 includes, sending, in the chatbot session, the knowledge-based question to the user; receiving an answer to the knowledge-based question from the user in the chatbot session; and using the answer as part of a behavior biometric sample of the user to authenticate the user.

In Example 11, the subject matter of Example 10 includes, initiating a second chatbot session with a user; receiving, in the second chatbot session, at least one message from the user; and authenticating the user based on at least a threshold match between a biometric sample corresponding to the at least one message and the behavior biometric sample.

Example 12 is at least one non-transitory machine-readable medium including instructions, which when executed by processing circuitry, cause the processing circuitry to perform operations comprising: initiating a chatbot session with a user; receiving, in the chatbot session, a prompt from the user related to suspected suspicious activity in an account of the user; generating a query based on the prompt; obtaining, using retrieval-augmented generation (RAG), contextual information corresponding to the query from corpus of documents; evaluating the prompt, the query, and the contextual information using a large language fraud model to determine a response to the prompt; and outputting, in the chatbot session, the response.

In Example 13, the subject matter of Example 12 includes, wherein the contextual information is obtained via a vector search of a corpus of documents.

In Example 14, the subject matter of Examples 12-13 includes, wherein the large language fraud model is configured to retrieve customer data corresponding to the account.

In Example 15, the subject matter of Examples 12-14 includes, wherein the large language fraud model is retrained using chatbot session data.

In Example 16, the subject matter of Examples 12-15 includes, wherein the response indicates that the suspected suspicious activity corresponded to fraud in the account, and further comprising placing a hold on the account.

In Example 17, the subject matter of Examples 12-16 includes, wherein the response to the prompt includes implementing at an account security measure including at least one of temporarily suspending account access, placing a hold on new transactions using the account, restricting electronic fund transfers using the account, disabling online banking capabilities of the account, or preventing charges to the account.

In Example 18, the subject matter of Examples 12-17 includes, wherein the response to the prompt includes providing educational materials to the user in the chatbot session.

In Example 19, the subject matter of Examples 12-18 includes, wherein the chatbot session is initiated in response to a step-up authentication requirement including at least one of detecting a potentially suspicious transaction pattern, identifying an unusual account access pattern, or requiring identity verification.

In Example 20, the subject matter of Examples 12-19 includes, wherein the chatbot session is initiated to verify the user through a knowledge-based question, and further comprising: sending, in the chatbot session, the knowledge-based question to the user; receiving an answer to the knowledge-based question from the user in the chatbot session; and using the answer as part of a behavior biometric sample of the user to authenticate the user.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
initiating a chatbot session with a user;
receiving, in the chatbot session, a prompt from the user related to suspected suspicious activity in an account of the user;
generating a query based on the prompt;
obtaining, using retrieval-augmented generation (RAG), contextual information corresponding to the query from corpus of documents;
evaluating the prompt, the query, and the contextual information using a large language fraud model to determine a response to the prompt; and
outputting, in the chatbot session, the response.

2. The method of claim 1, wherein the contextual information is obtained via a vector search of a corpus of documents.

3. The method of claim 1, wherein the large language fraud model is configured to retrieve customer data corresponding to the account.

4. The method of claim 1, wherein the large language fraud model is retrained using chatbot session data.

5. The method of claim 1, wherein the response indicates that the suspected suspicious activity corresponded to fraud in the account, and further comprising placing a hold on the account.

6. The method of claim 1, wherein the response to the prompt includes implementing at an account security measure including at least one of temporarily suspending account access, placing a hold on new transactions using the account, restricting electronic fund transfers using the account, disabling online banking capabilities of the account, or preventing charges to the account.

7. The method of claim 1, wherein the response to the prompt includes providing educational materials to the user in the chatbot session.

8. The method of claim 1, wherein the chatbot session is initiated in response to a step-up authentication requirement including at least one of detecting a potentially suspicious transaction pattern, identifying an unusual account access pattern, or requiring identity verification.

9. The method of claim 1, wherein the chatbot session is initiated to verify the user through a knowledge-based question.

10. The method of claim 9, further comprising:
sending, in the chatbot session, the knowledge-based question to the user;
receiving an answer to the knowledge-based question from the user in the chatbot session; and
using the answer as part of a behavior biometric sample of the user to authenticate the user.

11. The method of claim 10, further comprising:
initiating a second chatbot session with a user;
receiving, in the second chatbot session, at least one message from the user; and
authenticating the user based on at least a threshold match between a biometric sample corresponding to the at least one message and the behavior biometric sample.

12. At least one non-transitory machine-readable medium including instructions, which when executed by processing circuitry, cause the processing circuitry to perform operations comprising:
initiating a chatbot session with a user;
receiving, in the chatbot session, a prompt from the user related to suspected suspicious activity in an account of the user;
generating a query based on the prompt;
obtaining, using retrieval-augmented generation (RAG), contextual information corresponding to the query from corpus of documents;
evaluating the prompt, the query, and the contextual information using a large language fraud model to determine a response to the prompt; and
outputting, in the chatbot session, the response.

13. The at least one non-transitory machine-readable medium of claim 12, wherein the contextual information is obtained via a vector search of a corpus of documents.

14. The at least one non-transitory machine-readable medium of claim 12, wherein the large language fraud model is configured to retrieve customer data corresponding to the account.

15. The at least one non-transitory machine-readable medium of claim 12, wherein the large language fraud model is retrained using chatbot session data.

16. The at least one non-transitory machine-readable medium of claim 12, wherein the response indicates that the suspected suspicious activity corresponded to fraud in the account, and further comprising placing a hold on the account.

17. The at least one non-transitory machine-readable medium of claim 12, wherein the response to the prompt includes implementing at an account security measure including at least one of temporarily suspending account access, placing a hold on new transactions using the account, restricting electronic fund transfers using the account, disabling online banking capabilities of the account, or preventing charges to the account.

18. The at least one non-transitory machine-readable medium of claim 12, wherein the response to the prompt includes providing educational materials to the user in the chatbot session.

19. The at least one non-transitory machine-readable medium of claim 12, wherein the chatbot session is initiated in response to a step-up authentication requirement including at least one of detecting a potentially suspicious transaction pattern, identifying an unusual account access pattern, or requiring identity verification.

20. The at least one non-transitory machine-readable medium of claim 12, wherein the chatbot session is initiated to verify the user through a knowledge-based question, and further comprising:
sending, in the chatbot session, the knowledge-based question to the user;
receiving an answer to the knowledge-based question from the user in the chatbot session; and
using the answer as part of a behavior biometric sample of the user to authenticate the user.
